(19) United States
(12) Patent Application Publication
(10) Pub. No.: US 2017/0032703 A1
(43) Pub. Date: Feb. 2, 2017

(54) Simulated Organ

(71) Applicant: Seiko Epson Corporation, Tokyo (JP)

(72) Inventors: Hirokazu Sekino, Chino-shi (JP); Jiro Ito, Hokuto-shi (JP); Takeshi Seto, Shiojiri-shi (JP)

(21) Appl. No.: 15/195,755

(22) Filed: Jun. 28, 2016

(30) Foreign Application Priority Data
Jul. 30, 2015 (JP) 2015-150630

(51) Int. Cl. G09B 23/30

(52) U.S. Cl. CPC G09B 23/30

(57) ABSTRACT

A simulated organ includes a simulated blood vessel that simulates a blood vessel of a human body, and a simulated parenchyma that simulates a parenchyma cell of a human body, and in which the simulated blood vessel is embedded. The simulated parenchyma has a pressing pin breaking strength per unit area of 0.01 MPa to 0.07 MPa. In addition, the simulated blood vessel has a tensile breaking strength of 0.3 MPa to 1.5 MPa.

### BACKGROUND

1. Technical Field

The present invention relates to a simulated biological organ.

2. Related Art

In recent years, it has become common to improve surgical operating skills by practicing on simulated organs of the human body. An example of a simulated organ is found in JP-A-2012-203153, which proposes a simulated human organ surrounding simulated human blood vessels. The proposed simulated human organ consists of an initial simulated human muscle layer, a simulated parenchyma tissue layer overlying the simulated muscle layer, and a simulated skin layer on the simulated parenchyma tissue. In the proposed simulated human organ, the hardness relationship of the layers is defined after stacking the simulated muscle layer, the simulated parenchyma layer, and the simulated skin layer so as to simulate a human body part surrounding blood vessels.

An operation technique, or procedure, suitable for practice on a simulated organ includes using an injection needle to puncture from the surface of a simulated skin layer down to a simulated blood vessel of the simulated organ, but operating procedures suitable for practice on simulated organs are not limited to injections. Other operation techniques suitable for practice on simulated organs include incision (cutting into flesh) or excision (removal of flesh), particularly when the procedure is performed close to (e.g. along the periphery of) a simulated blood vessel. Of particular interest are operating procedures conducted with the use of a water jet scalpel. In this type of operation procedure (e.g. when the incision or the excision is performed on a simulated parenchyma along the periphery of a simulated blood vessel by using a pulse jet from a water jet scalpel), it is desirable that the simulated blood vessel not be damaged. It is therefore desirable that the simulated organ be able to indicate whether any damage would have been done to a human blood vessel by the operating procedure being practiced.

Although the simulated organ disclosed in JP-A-2012-203153 is suitable for practicing the purposeful puncturing of a blood vessel by use of an injection needle (e.g. application of a point-puncturing force), effects to a blood vessel due to a non-injection operation procedure conducted along its periphery is not taken into consideration. For example, when an incision, excision or other non-injection operating procedure is performed along the periphery of a human blood vessel, an extending force (or pressure) can sometimes be applied to the blood vessel, which may cause damage to the blood vessel.

It is therefore an object of the present invention to provide a simulated organ capable of indicating damage to a simulated blood vessel resulting from such an extending force, or from other forces resulting from an operating procedure conducted along the periphery of a simulated blood vessel.

### SUMMARY

An advantage of some aspects of the invention is to provide a simulated organ which is suitable for operation practice on the assumption that incision or excision is performed on a simulated parenchyma in a simulated blood vessel periphery.

The invention can be implemented as the following forms.

(1) An aspect of the invention provides a simulated organ. The simulated organ includes a simulated blood vessel that simulates a human blood vessel, and a simulated parenchyma that simulates a human parenchyma cell. The simulated blood vessel is embedded in the simulated parenchyma. The simulated parenchyma has a preferred pressing pin breaking strength per unit area of 0.01 MPa to 0.07 MPa. The simulated blood vessel has a preferred tensile breaking strength per unit area of 0.3 MPa to 1.5 MPa. In the simulated organ according to the present embodiment, even if a force is applied to the simulated parenchyma in a simulated blood vessel periphery (in the vicinity of, or proximate to, the simulated blood vessel) so that the simulated parenchyma can be broken and a force that extends (stretches) the simulated blood vessel is applied to the simulated blood vessel, the simulated blood vessel is not damaged.

In addition, the pressing pin breaking strength per unit area of simulated parenchyma is preferably 0.01 MPa to 0.07 MPa, which is substantially the same range as that of a human cerebral parenchyma cell. Therefore, in the simulated organ according to the present invention, an operation status can be provided on the assumption that incision or excision is performed on the simulated parenchyma in the simulated blood vessel periphery, in a state where a relationship of the pressing pin breaking strength with regard to the cerebral parenchyma cell of the human body is reflected.

(2) The simulated parenchyma may further have a pressing pin elastic modulus per unit area of 0.1 kPa to 6 kPa, and the simulated blood vessel may further have a tensile elastic modulus per unit area of 0.5 MPa to 1.5 MPa. The pressing pin elastic modulus per unit area of 0.1 kPa to 6 kPa is substantially the same range as that of a human cerebral parenchyma cell. Therefore, according to the simulated organ according to the aspect with this configuration, an operation status can be provided on the assumption that incision or excision is performed on the simulated parenchyma in the simulated blood vessel periphery, in a state where a relationship of the pressing pin elastic modulus with regard to the cerebral parenchyma cell of the human body is reflected.

(3) The simulated parenchyma may further have a loss elastic modulus of 150 Pa to 800 Pa, and the simulated blood vessel may further have a tensile breaking distortion rate of 1.0 to 3.0. The loss elastic modulus of 150 Pa to 800 Pa is substantially the same range as that of a human cerebral parenchyma cell. Therefore, using the simulated organ according to this configuration, an operation status can be provided on the assumption that incision or excision is performed on the simulated parenchyma in the simulated blood vessel periphery, in a state where a relationship of the loss elastic modulus with regard to the cerebral parenchyma cell of the human body is reflected.

(4) The simulated parenchyma may further have the pressing pin breaking strength per unit area of 0.015 MPa to 0.03 MPa, the pressing pin elastic modulus per unit area of 0.6 kPa to 5 kPa, and the loss elastic modulus of 250 Pa to 400 Pa. Using the simulated organ according to this configuration, an operation status can be provided on the assumption that incision or excision is performed on the simulated parenchyma in the simulated blood vessel periphery, in a state where the pressing pin breaking strength, the pressing pin elastic modulus, and the loss elastic modulus per unit area of the simulated parenchyma are much further reflected by simulating the cerebral parenchyma cell of the human body.

(5) Another aspect of the invention provides a simulated organ. The simulated organ includes a simulated blood vessel that simulates a human blood vessel, and a simulated parenchyma that simulates a human parenchyma cell. The simulated blood vessel is embedded in the simulated parenchyma. The simulated parenchyma has a preferred pressing pin breaking strength per unit area of 0.01 MPa to 0.07 MPa. Using the simulated organ according to this aspect, an operation status can be provided on the assumption that incision or excision is performed on the simulated parenchyma having the simulated blood vessel embedded therein, in a state where the pressing pin breaking strength per unit area with regard to the cerebral parenchyma cell of the human body is reflected.

(6) Still another aspect of the invention provides a simulated organ. The simulated organ includes a simulated blood vessel that simulates a human blood vessel, and a simulated parenchyma that simulates a human parenchyma cell. The simulated blood vessel is embedded in the simulated parenchyma. The simulated blood vessel has a preferred tensile breaking strength per unit area of 0.3 MPa to 1.5 MPa. Using a simulated organ according to this aspect, an operation status can be provided on the assumption that incision or excision is performed on the simulated parenchyma in the simulated blood vessel periphery, in a state where damage to the simulated blood vessel is inhibited even if a force to extend the simulated blood vessel is applied to the simulated blood vessel.

The invention can be implemented in various forms in addition to the above-described configurations. For example, the invention can be implemented as a manufacturing method of the simulated organ.

### BRIEF DESCRIPTION OF THE DRAWINGS

The invention will be described with reference to the accompanying drawings, wherein like numbers reference like elements.

FIG. 1 is a schematic view of a configuration of a liquid ejecting apparatus.

FIG. 2 is a top view of a simulated organ.

FIG. 3 is a sectional view taken along line 3-3 of FIG. 2.

FIG. 4 is a view for describing a test for pressing pin breaking strength.

FIG. 5 is a view illustrating test data obtained by the above-described strength test.

FIG. 6 is a schematic view of a mechanism for measuring a loss elastic modulus.

FIG. 7 is a view for describing a tension test for obtaining a physical property such as tensile breaking strength.

FIG. 8 is a view illustrating test data obtained by a tension test.

FIG. 9 is a flowchart illustrating a manufacturing procedure of the simulated organ.

FIG. 10 is a top view for describing a state where a first flexible member has been inserted into a first member.

FIG. 11 is a sectional view taken along line 11-11 illustrated in FIG. 10.

FIG. 12 is a top view for describing a state where a first simulated blood vessel, a second simulated blood vessel, and a third simulated blood vessel have been arranged.

FIG. 13 is a view for describing a sectional view taken along line 13-13 of FIG. 12 together with an assembly state of a second member.

FIG. 14 is a top view for describing a state where a second flexible member has been inserted.

FIG. 15 is a sectional view taken along line 15-15 of FIG. 14.

FIG. 16 is a top view for describing a state where a simulated parenchyma has been arranged.

FIG. 17 is a sectional view taken along line 17-17 of FIG. 16.

FIG. 18 is a top view for describing an excision portion.

FIG. 19 is a sectional view taken along line 19-19 of FIG. 18.

### DESCRIPTION OF EXEMPLARY EMBODIMENTS

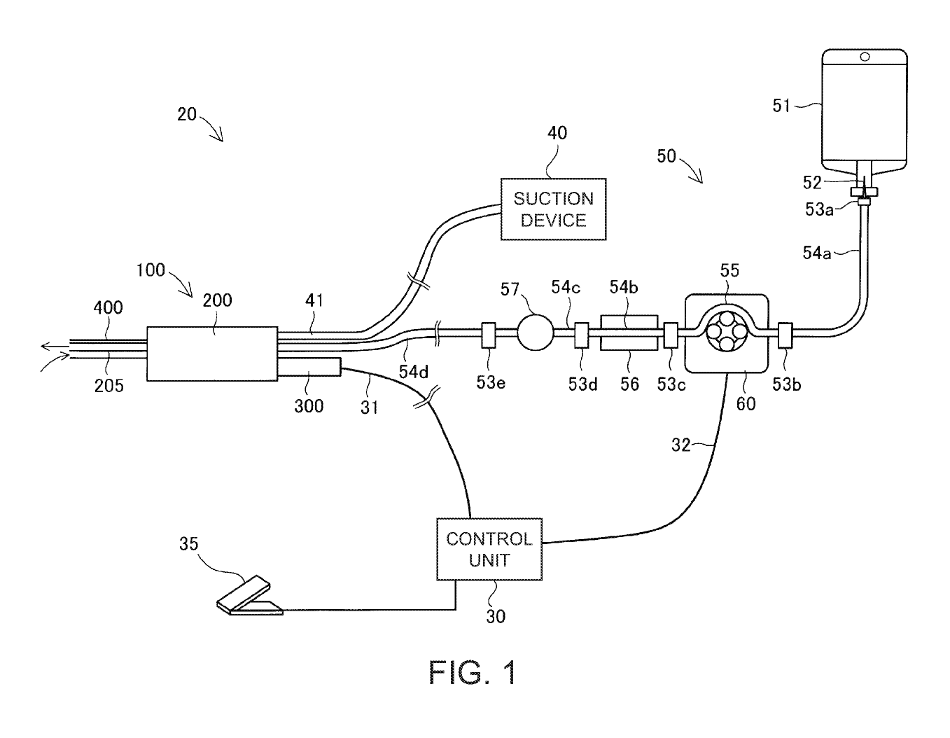

FIG. 1 is a schematic view of a liquid ejecting apparatus 20. The liquid ejecting apparatus 20 is a medical device used in medical institutions, and is used to incise and excise a lesion by ejecting a liquid at the lesion in a pulse-like manner.

The liquid ejecting apparatus 20 includes a control unit (i.e. controller) 30, an actuator cable 31, a pump cable 32, a foot switch 35, a suction device (e.g. vacuum) 40, a suction tube 41, a liquid supply device (i.e. liquid supply, or liquid supplier or liquid reservoir) 50, and a handpiece 100.

The liquid supply device 50 includes a water supply bag 51, a spike needle 52, a plurality of connectors (preferably first to fifth connectors 53a to 53e), a plurality of water supply tubes (preferably first to fourth water supply tubes 54a to 54d), a pump tube 55, a clogging detection mechanism (i.e. clog detector) 56, and a filter 57. The handpiece 100 includes a nozzle unit (i.e. nozzle) 200 and an actuator unit (i.e. actuator) 300. The nozzle unit 200 includes an ejecting tube 205 and a suction pipe 400.

The water supply bag 51 is preferably made of a transparent synthetic resin, and the inside thereof is filled with a liquid (preferably, a physiological saline solution). In the present application, the water supply bag is called a “water supply bag” even if it is filled with liquids other than water. The spike needle 52 is connected to the first water supply tube 54a via the first connector 53a. If the spike needle 52 is stuck into the water supply bag 51, the liquid filling the water supply bag 51 is in a state where the liquid can be supplied to the first water supply tube 54a.

The first water supply tube 54a is connected to the pump tube 55 via the second connector 53b. The pump tube 55 is connected to the second water supply tube 54b via the third connector 53c. The tube pump 60 pinches the pump tube 55. The tube pump 60 feeds (i.e. pumps) the liquid from the first water supply tube 54a side to the second water supply tube 54b side through the pump tube 55.

The clogging detection mechanism 56 detects clogging inside the first to fourth water supply tubes 54a to 54d by measuring pressure inside the second water supply tube 54b.

The second water supply tube 54b is connected to the third water supply tube 54c via the fourth connector 53d. The filter 57 is connected to the third water supply tube 54c. The filter 57 collects foreign substances contained in the liquid.

The third water supply tube 54c is connected to the fourth water supply tube 54d via the fifth connector 53e. The fourth water supply tube 54d is connected to the nozzle unit 200. The liquid supplied through the fourth water supply tube 54d is intermittently ejected from a distal end of the ejecting tube 205 by driving the actuator unit 300. The liquid is intermittently ejected in this way. Accordingly, it is possible to ensure excision capability using a small flow rate.

The ejecting tube 205 and the suction pipe 400 configure a double tube in which the ejecting tube 205 serves as an inner tube and the suction pipe 400 serves as an outer tube. The suction tube 41 is connected to the nozzle unit 200. The suction device 40 applies suction to the inside of the suction pipe 400 through the suction tube 41. The suction is applied to the liquid or excised fragments in the vicinity of the distal end of the suction pipe 400.

The control unit 30 controls the tube pump 60 and the actuator unit 300. Specifically, while the foot switch 35 is stepped on (i.e. actuated or switched on), the control unit 30 transmits a drive signal via the actuator cable 31 and the pump cable 32. The drive signal transmitted via the actuator cable 31 drives a piezoelectric element (not illustrated) included (i.e. housed) in the actuator unit 300. The drive signal transmitted via the pump cable 32 drives the tube pump 60. Accordingly, while a user steps on the foot switch 35, the liquid is intermittently ejected. While the user does not step on the foot switch 35, no drive signal is transmitted and liquid ejection is stopped.

Hereinafter, a simulated organ will be described. The simulated organ is also called a phantom, and is an artificial product of which a portion is excised by the liquid ejecting apparatus 20 in the present embodiment. The simulated organ according to the present embodiment is used in performing a simulated operation, such as for the purpose of a performance evaluation of the liquid ejecting apparatus 20, practicing manipulation of the liquid ejecting apparatus 20, and the like.

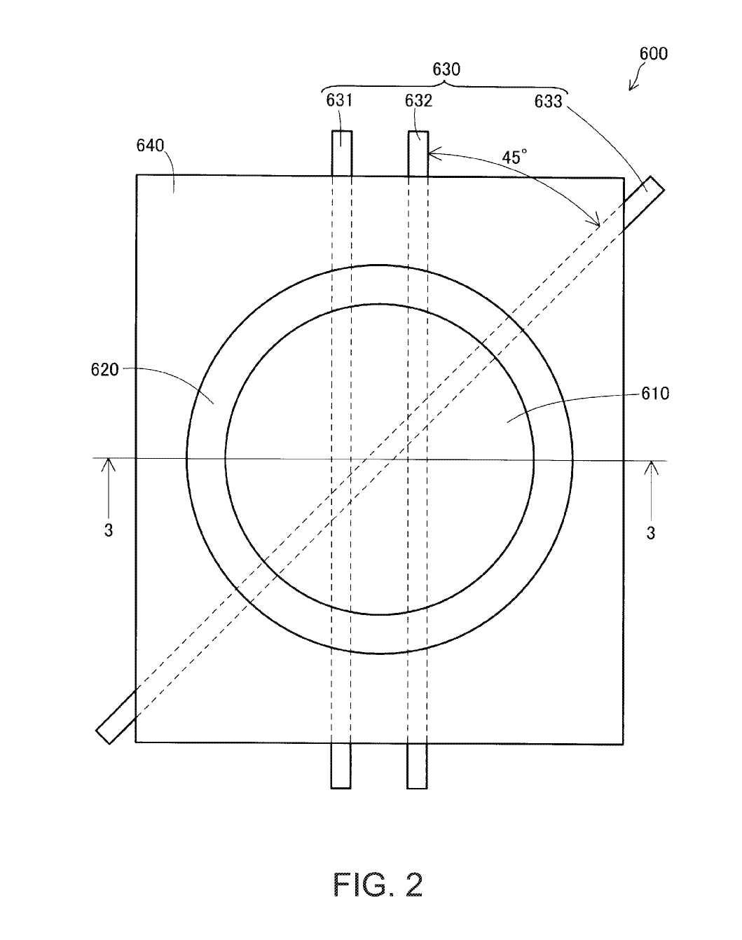

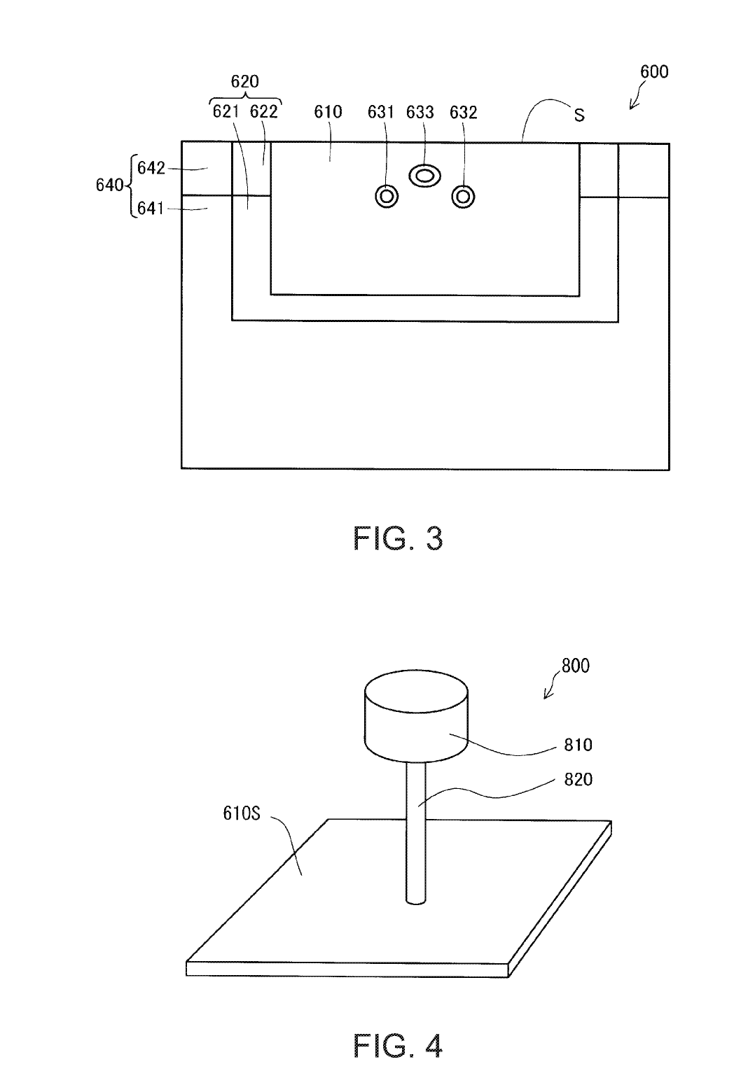

FIG. 2 is a top view of a simulated organ 600 in accord with the present invention. FIG. 3 is a sectional view taken along line 3-3 illustrated in FIG. 2. The simulated organ 600 includes a simulated parenchyma 610, a flexible member 620, a first simulated blood vessel 631, a second simulated blood vessel 632, a third simulated blood vessel 633, and a case 640. In some cases, the first simulated blood vessel 631, the second simulated blood vessel 632, and the third simulated blood vessel 633 may be collectively referred to as a simulated blood vessel 630.

With reference to FIG. 3, the case 640 includes a first case member 641 and a second case member 642. The second case member 642 is fixed onto the first case member 641, thereby configuring the case 640. A reason for configuring the case 640 to have two case members in this way is to facilitate manufacturing of the simulated organ 600 (details will be described later).

The first case member 641 and the second case member 642 are manufactured by using a material having sufficient rigidity for supporting the flexible member 620 and the simulated blood vessel 630 (iron, aluminum, a hard resin, or the like). In order to have the above-described sufficient rigidity, the first case member 641 and the second case member 642 are formed of a material having a sufficiently higher elastic modulus compared to the flexible member 620. Preferably, the elastic modules of the first case member 641 and the second case member 642 are at least 2 times greater than that of the flexible member 620.

In the present preferred embodiment, the case 640 is constructed of a transparent resin material. Since the case 640 is preferably transparent, the flexible member 620 is visible from any side surface of the case 640.

The flexible member 620 is arranged inside a cylindrical recess formed in a central portion of the case 640. The flexible member 620 is formed of two sub-members such that a first flexible sub-member 621 and a second flexible sub-member 622 are stacked on each other. The flexible member 620 has a recessed region so that the simulated parenchyma 610 can be held therein, and has a cylindrical cup shape (i.e. an open cylinder with a sealed base). The flexible member 620 is formed of a material that is softer than that of the case 640 and harder than that of the simulated parenchyma 610. The flexible member 620 according to the present embodiment is formed of a material whose pressing pin (e.g. point-puncturing) breaking strength is five times that of the simulated parenchyma 610, and whose elastic modulus is also five times that of the simulated parenchyma 610.

The simulated parenchyma 610 is an artificial product that simulates a parenchyma (parenchyma cell (s)), which is a cell (or tissue) having a fundamental (or characteristic) physiological function of a human body organ (for example, a human brain, liver, or the like). According to the present embodiment, the simulated parenchyma 610 simulates a cerebral parenchyma cell of a human body, and is arranged in the cylindrical recess formed in the central portion of the flexible member 620. The simulated parenchyma 610 is a target portion of incision and excision using the liquid ejecting apparatus 20.

The simulated blood vessel 630 is an artificial product that simulates a cerebral blood vessel of the human body. The simulated blood vessel 630 is held by the case 640, and is embedded in the simulated parenchyma 610. The simulated blood vessel 630 preferably penetrates the simulated parenchyma 610, the flexible member 620, and the case 640. As stated above, the simulated blood vessel 630 may collectively represent multiple blood vessels. In the present case, simulated blood vessel 630 preferably represents three separate blood vessels: the first simulated blood vessel 631, the second simulated blood vessel 632, and the third simulated blood vessel 633, all of which are preferably arranged substantially horizontal.

The first simulated blood vessel 631 and the second simulated blood vessel 632 are arranged so each crosses the third simulated blood vessel 633 at a distinct, respective interception point. The first simulated blood vessel 631 and the second simulated blood vessel 632 are preferably arranged parallel to each other, and thus do not cross (or intercept) each other. The term “intersection point” is used herein to described a crossing point where the first simulated blood vessel 631 and the second simulated blood vessel 632 respectively cross the third simulated blood vessel 633 on separate plains. That is, the term intercepting point is used herein to loosely refer to what would be a true interception point of two simulated blood vessels on separate plains if the simulated blood vessels were projected onto a common surface (i.e. plain) S (FIG. 3), which in the present example corresponds to the top surface plain of the simulated organ 600 and provides a view as seen from above (as illustrated in FIG. 2). The surface S comes into contact with an upper end of the case 640 and comes into contact with a surface on which the simulated parenchyma 610 is exposed from the case 640.

According to the embodiment, the first to third simulated blood vessels are arranged so that three are not parallel to each other. The first simulated blood vessel 631 and the second simulated blood vessel 632 are arranged parallel to each other. The third simulated blood vessel 633 is preferably arranged so that it crosses the first simulated blood vessel 631 and second simulated blood vessel 632 at an angle of 45° on a horizontal plane. The third simulated blood vessel 633 is preferably on a higher plain than the first 631 and second 632 simulated blood vessels so that the third simulated blood vessel 633 crosses the first simulated blood vessel 631 and the second simulated blood vessel 632 in an overhead crossing manner. At any given crossing point, the third simulated blood vessel 633 is located over the first simulated blood vessel 631 or the second simulated blood vessel 632 (refer to FIG. 3).

Hereinafter, physical properties of the simulated parenchyma 610 and the simulated blood vessel 630 will be described. The simulated organ 600 according to the present embodiment is manufactured on the assumption that it simulate brain tissue, i.e. that it will be used in a simulated operation on a human brain. It is known that pig cerebral tissues and a pig cerebral blood vessel, specifically a pig cerebral parenchyma having the cerebral blood vessel embedded therein, have substantially the same degree of strength as those of a human. Accordingly, as a substitute for testing on human brains, various attributes of the simulated parenchyma 610 are based on pig cerebral tissues and pig cerebral blood vessels. For example, a target pressing pin breaking strength per unit area (hereinafter, simply referred to as pressing pin breaking strength), a pressing pin elastic modulus per unit area (hereinafter, simply referred to as a pressing pin elastic modulus), and a loss elastic modulus are all determined from pig cerebral parenchyma for testing the performance of the simulated parenchyma 610. In addition, the simulated blood vessel's 630 target tensile breaking strength, tensile elastic modulus, and tensile breaking distortion rate are all based on those of pig cerebral blood vessels. This point will be described, based on the above-described physical properties in the simulated parenchyma 610.

It has been found that the pig cerebral parenchyma has a pressing pin breaking strength of 0.02 MPa (megapascals) to 0.06 MPa, a pressing pin elastic modulus of 0.5 kPa (kilopascals) to 5 kPa, and a loss elastic modulus of 200 Pa (pascals) to 600 Pa. These physical property values are obtained from actual measurement results of pig cerebral parenchyma in various physical property value measurement devices (to be described later) or various research results. The strength of the simulated parenchyma 610 can be changed by changing a manufacturing condition of polyvinyl alcohol (PVA). For this reason, according to the present embodiment, the strength of the simulated parenchyma 610 is adjusted to reflect the above-described physical property values of the pig cerebral parenchyma by adjusting the manufacturing conditions of the PVA during the manufacture of the simulated parenchyma 610.

FIG. 4 illustrates a mechanism for test ing the pressing pin breaking strength. A simulated parenchyma test sample 610S illustrated in the drawing is a test sample of the simulated parenchyma 610, which is formed in order to adjust the strength of the PVA under the same condition as the manufacturing condition of the simulated parenchyma 610. A strength measuring machine 800 (for example, the Table-top Material Tester EZ-S manufactured by Shimadzu Corporation) presses a pin 820 against the test sample by using a load cell 810. The thickness of the test sample is adjusted in accordance with a measurement condition in the strength measuring machine 800.

The simulated parenchyma test sample 610S is subjected to the strength test after being placed on a test table (not illustrated) of the above-described strength measuring machine 800. The strength measuring machine 800 applies a press ing force of the load cell 810 via the pin 820 to the simulated parenchyma test sample 610S being subjected to the strength test. In the strength test, the pin 820 is pressed and deformed until the simulated parenchyma test sample 610S starts to break. The pressing force of the pin 820 during this deformation process is measured from the load cell 810 on a real time basis. The pin 820 used in measuring pressing pin breaking strength of the simulated parenchyma test sample 610S which is the test sample of the simulated parenchyma 610 has a pin diameter of 1.0 mm, and is pressed into the test sample at pressing speed of 1 mm/s.

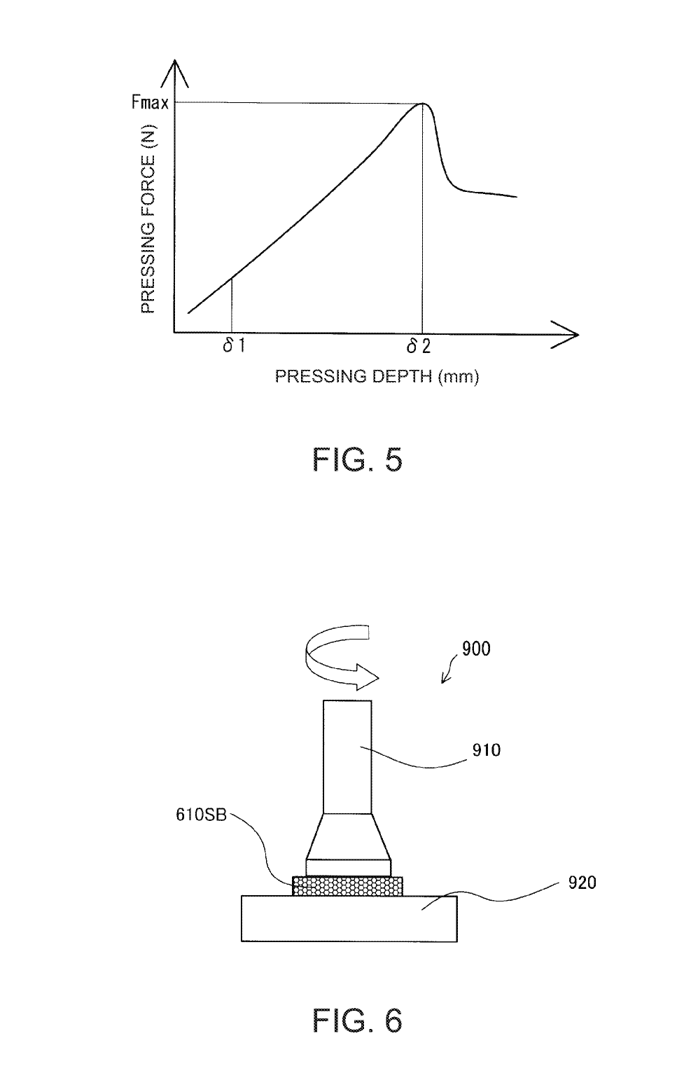

FIG. 5 is a view illustrating test data obtained by the above-described strength test. The vertical axis represents the pressing force of the pin 820, and the horizontal axis represents a pressing depth obtained by the pin 820. The pin 820 is pressed at the speed of 1 mm/s. Accordingly, as illustrated in FIG. 5, the pressing depth increases with the lapse of time, and the pressing force increases so as to be substantially linear with respect to the pressing depth. The physical property values of the simulated parenchyma 610 are obtained from a graph in FIG. 5 in the following manner.

As illustrated in FIG. 5, until the pressing depth reaches a depth δ2, the pressing force also increases due to an increase in the pressing depth. The pressing pin elastic modulus (measured in MPa) of the simulated parenchyma test sample 610S is calculated as a portion of a linear region, based on a data gradient in a region whose pressing depth reaches a depth δ1, which is less than δ2. The calculation employs Equation (1) below. Equation (1) is a Hertz Sneddon equation.

F=2R{E/(1−ν²)}δ (1)

In Equation (1), F represents the pressing force, R represents the radius of the pin tip of pin 820, E represents an elastic modulus, ν represents Poisson's ratio, and δ represents the pressing depth. It is preferable to set the depth δ1 to a value having such a degree that the value approximates the gradient of the data in a linear region of the data. On the other hand, the Hertz Sneddon equation is effective in a case where the depth δ is sufficiently smaller than the radius R (=0.5 mm) of the pin tip. Accordingly, it is preferable to set the depth δ1 so as to be sufficiently smaller than the radius R of the pin tip. If Equation (1) is modified, Equation (2) is obtained as follows.

E={(1−ν²)/2R}(F/δ) (2)

In Equation (2), F/δ represents the data gradient. Poisson's ratio ν can employ 0.49 as an estimate value, based on the fact that the simulated parenchyma test sample 610S is substantially incompressible. The radius R of the pin tip is known as described above. Accordingly, it is possible to calculate a pressing pin elastic modulus E of the simulated parenchyma test sample 610S by measuring the data gradient.

As illustrated in FIG. 5, the pressing force peaks at a certain pressing depth. The reason that the pressing force peaks is that the simulated parenchyma test sample 610S breaks at that point. The pressing force peak is designated the maximum pressing force Fmax, and the pressing depth at the maximum pressing force Fmax is designated depth δ2. The pressing pin breaking strength P (MPa) can be calculated by Equation (3), below. The radius R in this equation is as described above.

P=Fmax/(πR²) (3)

Various adjustments of the PVA for manufacturing the simulated parenchyma 610 are defined by manufacturing the simulated parenchyma test sample 610S in which the strength of the PVA is completely adjusted and by repeatedly performing the above-described test. The objective is to obtain a simulated parenchyma whose range of pressing pin breaking strength encompasses the range of that of pig parenchyma, and whose range of pressing pin elastic modulus encompasses the range of that of pig parenchyma. As stated above, pig cerebral parenchyma has a pressing pin breaking strength ranging from 0.02 MPa to 0.06 MPa, so the simulated parenchyma is preferably made to have a pressing pin breaking strength ranging from 0.01 MPa to 0.07 MPa. Also as stated above, pig cerebral parenchyma has a pin elastic modulus ranging from 0.5 kPa to 5 kPa, so the simulated parenchyma is made to have a pressing pin elastic modulus ranging from 0.1 kPa to 6 kPa. The simulated parenchyma is also made to have a loss elastic modulus (to be described below) that mimics that of a pig cerebral parenchyma. The defined various adjustments of the PVA are performed in a manufacturing process (to be described later). Then, the simulated parenchyma 610 manufactured through the defined various adjustments of the PVA is a product in which the physical property values of the pig cerebral parenchyma are reflected with regard to the pressing pin breaking strength and the pressing pin elastic modulus.

Optionally, the strength of the PVA may be adjusted to create a simulated parenchyma 610 that has a pressing pin breaking strength of 0.015 MPa to 0.03 MPa, and thus is weaker than that of a pig cerebral parenchyma (i.e. the target tissue to be simulated). Similarly, the simulated parenchyma 610 may be made to have a pressing pin elastic modulus of 0.6 kPa to 5 kPa, and thus is within the range of that of a pig cerebral parenchyma. In this manner, if a surgical procedure practiced on the simulated parenchyma results in no damage to the simulated parenchyma, then one may be confident that a similar procedure practiced on a real pig cerebral parenchyma (or real human parenchyma) would also result in no damage to the real parenchyma.

According to the embodiment, with regard to the simulated parenchyma 610, in addition to the pressing pin breaking strength and the pressing pin elastic modulus, which are described above, the loss elastic modulus is also defined as follows. The loss elastic modulus is a physical property value of a viscoelastic body which is observed when a sinusoidal oscillation distortion is given to the viscoelastic body, and can be measured with regard to the pig cerebral parenchyma which is the viscoelastic body. FIG. 6 is a view schematically illustrating a mechanism for measuring the loss elastic modulus. A dynamic viscoelasticity measuring device 900 illustrated in the drawing (such as instrument model DHR-2 manufactured by TA Instruments) causes a parallel plate 910 to pinch a sample 610SB placed on a sample table 920 provided with a slip function, and applies the sinusoidal oscillation distortion to the sample 610SB, and measures the loss elastic modulus based on distortion appearing in the sample. In the drawing, a cylindrical simulated parenchyma test sample 610SB is illustrated as the sample. The simulated parenchyma test sample 610SB is used as a substitute for a real parenchyma in order to measure the loss elastic modulus of the simulated parenchyma 610. In order to define the loss elastic modulus of the simulated parenchyma 610, the loss elastic modulus of the pig cerebral parenchyma is first measured by using the dynamic viscoelasticity measuring device 900 illustrated in FIG. 6. In the measurement, the pig cerebral parenchyma having the same size as that of the simulated parenchyma test sample 610SB illustrated in the drawing is prepared, and the loss elastic modulus of the pig cerebral parenchyma is measured. The loss elastic modulus is measured with regard to a plurality of cerebral parenchyma cells of a different portion or the cerebral parenchyma of a different solid. As a result, it has been confirmed that the pig cerebral parenchyma has a loss elastic modulus of 200 Pa to 600 Pa.

According to the embodiment, conditions for various adjustments of the PVA are defined so that a loss elastic modulus (G″) of the simulated parenchyma test sample 610SB is made to be 150 Pa to 800 Pa, which encompasses the observed elastic modulus of the pig cerebral parenchyma. Under the defined adjustment conditions of the PVA, the simulated parenchyma 610 is manufactured in a manufacturing process (to be described later), thereby manufacturing the simulated parenchyma 610 to have the loss elastic modulus (G″) of 150 Pa to 800 Pa. This simulated parenchyma 610 is then used in the construction of the simulated organ 600 illustrated in FIG. 2.

If desired, the loss elastic modulus (G″) of the simulated parenchyma 610 can be set to 250 Pa to 400 Pa by adjusting the strength of the PVA. A measurement condition of the loss elastic modulus in the dynamic viscoelasticity measuring device 900 (e.g. instrument DHR-2 manufactured by TA instruments), is as follows.
Size of Parallel Plate 910 (diameter): 020 mm
Sinusoidal Frequency: 1 Hz
Sinusoidal Oscillation Distortion: 1%
Temperature for Test: 20° C.
Sample Size (diameter×thickness): ø25×5 (mm)

Next, physical property values of the simulated blood vessel 630 (see FIG. 2) will be described. The simulated organ 600 according to the present embodiment is manufactured on the assumption that a force to extend the blood vessel 630 can be applied to the simulated blood vessel 630. Accordingly, the following assumes the physical property values relating to the extension of the pig cerebral blood vessel, tensile breaking strength per unit area (hereinafter, simply referred to as tensile breaking strength), tensile elastic modulus per unit area (hereinafter, simply referred to as tensile elastic modulus), and tensile breaking distortion rate. It has been found that the pig cerebral blood vessel has a tensile breaking strength of 0.5 MPa to 1.2 MPa, a tensile elastic modulus of 0.7 MPa to 1.2 MPa, and a tensile breaking distortion rate of 1.2 to 2.7. These physical property values are obtained from experimental results on pig cerebral blood vessels. For example, the strength measuring machine 800 of FIG. 4 may be used on a pig cerebral blood vessel to measure its actual tensile property, such as its tensile strength, or the physical property values may be obtained from various research results. Then, the simulated blood vessel 630 is manufactured by using the polyvinyl alcohol (PVA). As is known, the strength of the PVA can be changed by changing the manufacturing condition. For this reason, according to the present embodiment, the manufacturing condition of the PVA when the simulated blood vessel 630 is manufactured is defined so that the above-described physical property values of the pig cerebral blood vessel are reflected.

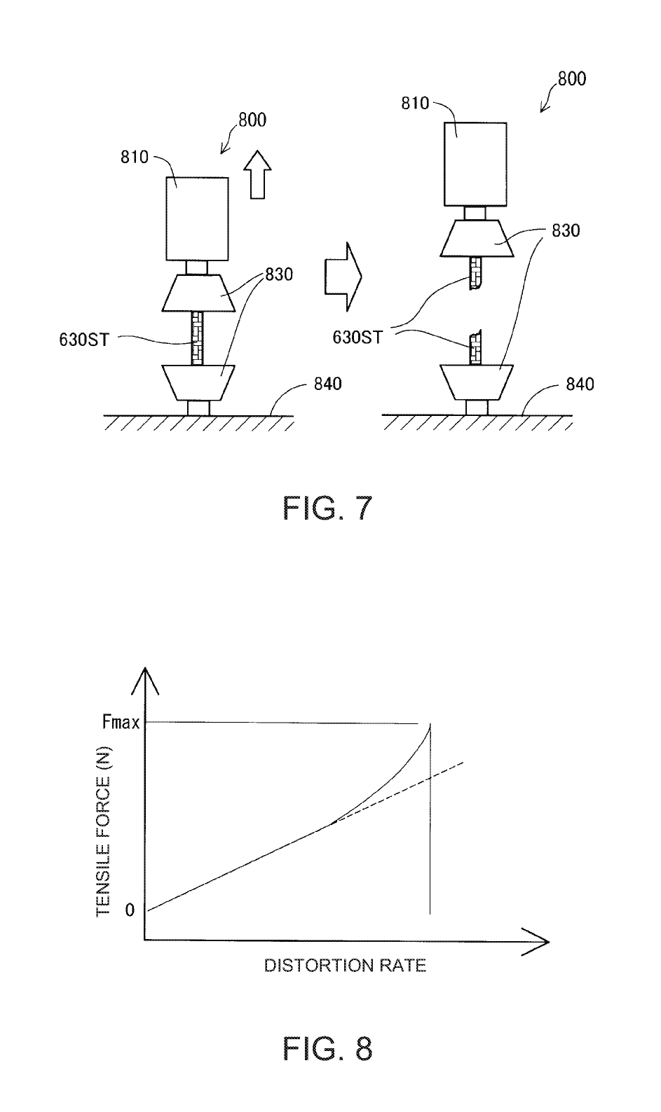

FIG. 7 is a view for describing a tension test (i.e. tensile test) for obtaining a physical property such as tensile breaking strength. A simulated blood vessel sample 630ST illustrated in the drawing is a test sample of the simulated blood vessel 630 manufactured in a hollow blood vessel shape under the same manufacturing condition as that of the simulated blood vessel 630. The simulated blood vessel 630 itself may be the simulated blood vessel sample 630ST. In the tension test, the previously described strength measuring machine 800 (such as Table-top Material Tester EZ-S manufactured by Shimadzu Corporation) can be used. Accordingly, as illustrated in the drawing, one gripping jig 830 is respectively mounted on each of the load cell 810 and the table 840, and both ends of the sample gripping jigs 830 are used to grip the simulated blood vessel sample 630ST. After a defined measurement length of the simulated blood vessel sample 630ST is gripped in this way, the tension test starts. Alternatively, the simulated blood vessel sample 630ST may be manufactured in a tape shape having a rectangular cross section.

The strength measuring machine 800 lifts the load cell 810 at constant speed so as to apply tensile strength (hereinafter, referred to as a tensile force) to the simulated blood vessel sample 630ST under test, and pulls the simulated blood vessel sample 630ST until the simulated blood vessel sample 630ST breaks. The simulated blood vessel sample 630ST extends with the lapse of time during the tension test until it finally breaks. The strength measuring machine 800 measures in real time the tensile force generated during this tension process from the load cell 810. According to the present embodiment, the tension test was performed at tensile speed of 1 mm/sec.

FIG. 8 illustrates test data obtained by the tension test. The vertical axis represents the tensile force applied per unit time, and the horizontal axis represents a distortion rate obtained by dividing a current length of the simulated blood vessel sample 630ST at each elapsed time unit by its initial test length (i.e. the starting distance between the two sample gripping jigs 830). The simulated blood vessel sample 630ST is pulled at a preferred speed of 1 mm/sec. Therefore, the horizontal axis in FIG. 8 also corresponds to the elapsed time. Accordingly, as illustrated in FIG. 8, the tensile force increases with the lapse of time, or equally, as the distortion rate increases. As is illustrated in FIG. 8, the tensile force increases so as to be substantially linear with respect to the distortion rate within an initial period when the test starts. The physical property values of the simulated blood vessel sample 630ST are obtained from the graph in FIG. 8 as follows.

As illustrated in FIG. 8, the tensile force initially increases linearly with respect to the distortion rate as the test starts. Thereafter, the increasing tensile force inflects (e.g. deviates from its linear path) when approaching its peak, and the tensile force rapidly drops from its peak to zero. The tensile force peaks when the simulated blood vessel sample 630ST breaks. Accordingly, the maximum tensile force Fmax and the distortion rate when the tensile force peaks are obtained as the tensile breaking strength and the tensile breaking distortion rate. The tensile breaking strength is obtained in such a way that the maximum tensile force Fmax is divided by a vascular theory cross-sectional area belonging to the simulated blood vessel sample 630ST. Then, the tensile breaking distortion rate is obtained by using a ratio of a stroke (extension: mm) until the peak to the defined length (mm) of the simulated blood vessel sample 630ST when the tension test starts. In addition, the tensile elastic modulus is calculated, based on a gradient of the tensile force in a linear region of tensile force transition at the initial starting time of the tension test in FIG. 8.

Various adjustments of the PVA for manufacturing the simulated blood vessel 630 are defined by manufacturing the simulated blood vessel sample 630ST using the PVA and by repeatedly performing the above-described tension test, so as to obtain a simulated blood vessel having a tensile breaking strength of 0.3 MPa to 1.5 MPa, which encompasses the tensile breaking strength (0.5 MPa to 1.2 MPa) of a pig cerebral blood vessel. The obtained simulated blood vessel preferably has a tensile elastic modulus of 0.5 MPa to 1.5 MPa, which encompasses the tensile elastic modulus (0.7 MPa to 1.2 MPa) of a pig cerebral blood vessel. The obtained simulated blood vessel also preferably has a tensile breaking distortion rate of 1.0 to 3.0, which encompasses the tensile breaking distortion rate (1.2 to 2.5) of a pig cerebral blood vessel.

The defined various adjustments of the PVA are performed in a manufacturing process (to be described later). Then, the simulated blood vessel 630 manufactured through the defined various adjustments of the PVA is a product in which the physical property values of the pig cerebral blood vessel are reflected with regard to the tensile breaking strength, the tensile elastic modulus, and the tensile breaking distortion rate. In this case, the strength of the PVA may alternatively be adjusted in various ways to provide a tensile breaking strength to become 0.7 MPa to 1.0 MPa, the tensile elastic modulus to become 0.8 MPa to 1.0 MPa, and/or the tensile breaking distortion rate to become 1.4 to 2.0 so that the above-described physical property values of the simulated blood vessel 630 may further approximate the pig cerebral blood vessel.

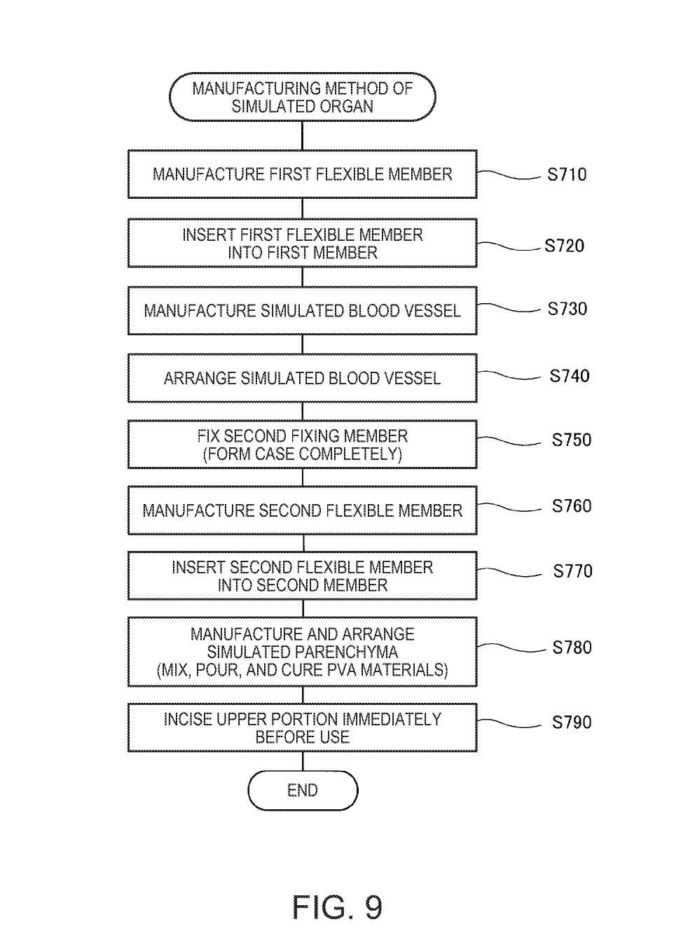

FIG. 9 is a flowchart illustrating a manufacturing procedure of the simulated organ 600. The first flexible sub-member 621 (see FIG. 3) is manufactured first (Step S710). Specifically, a mixture obtained by mixing and stirring a main agent of urethane and a curing agent is poured into a separately prepared die (not illustrated). Thereafter, the urethane is gelled into elastomeric gel, thereby forming the first flexible sub-member 621. According to this die molding, it is possible to obtain a first flexible sub-member 621 that has a recessed shape and whose upper end is open.

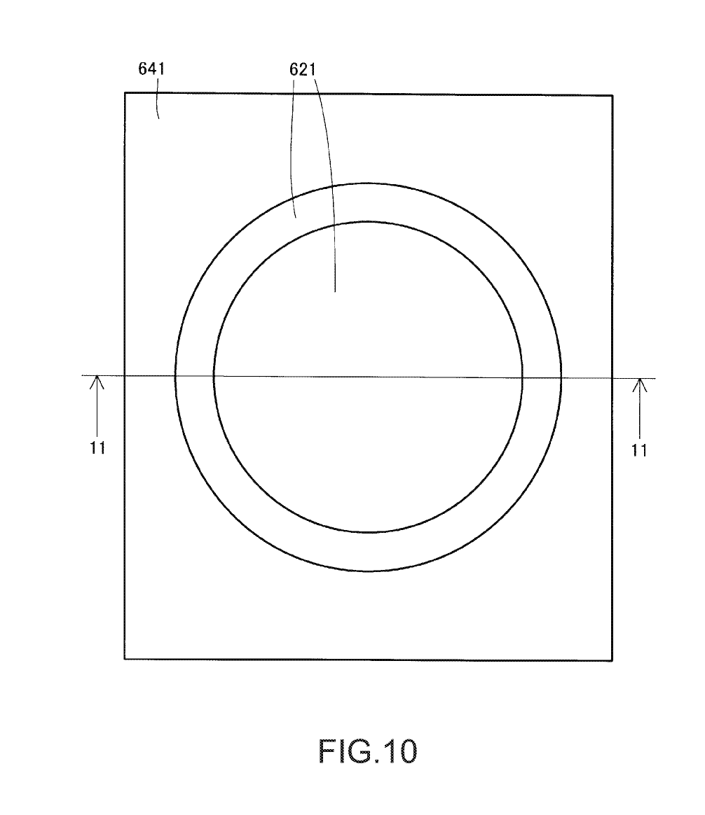

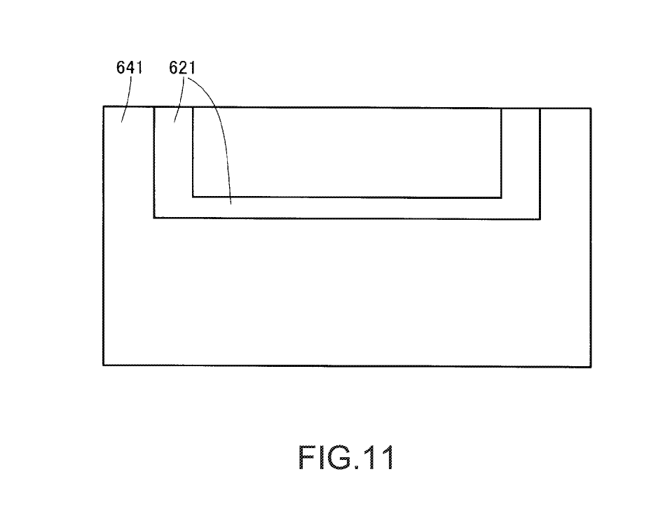

Next, the first flexible sub-member 621 is inserted into the recess of the first case member 641, see FIG. 3, (Step S720). FIG. 10 is a top view for describing a state where the first flexible sub-member 621 has been inserted into the first case member 641. FIG. 11 is a sectional view taken along line 11-11 illustrated in FIG. 10.

Next, the simulated blood vessel 630 is manufactured (Step S730). As a material for the simulated blood vessel 630, the embodiment employs polyvinyl alcohol (PVA). If desired in the present embodiment, the simulated blood vessel 630 may be a hollow member, and thus, the following manufacturing method can be employed. According to the method, an outer periphery of an extra fine wire is coated with the PVA prior to curing, and the extra fine wire is pulled out after the PVA is cured. The outer diameter of the extra fine wire is aligned with the inner diameter of the blood vessel. The extra fine wire is made of metal, and may be formed of a piano wire, for example. In manufacturing the simulated blood vessel 630 by using the PVA, as described previously, the manufacturing conditions of the PVA are adjusted so as to obtain a preferred tensile breaking strength of 0.3 MPa to 1.5 MPa, the tensile elastic modulus of 0.5 MPa to 1.5 MPa, and the tensile breaking distortion rate of 1.0 to 3.0. The simulated blood vessel 630 is formed by using the PVA whose manufacturing conditions have been adjusted, and by using an extra fine wire, such as a piano wire. In a case where the first simulated blood vessel 631, the second simulated blood vessel 632, and the third simulated blood vessel 633 are set to be different simulated blood vessels, extra fine wires of different diameters may be used.

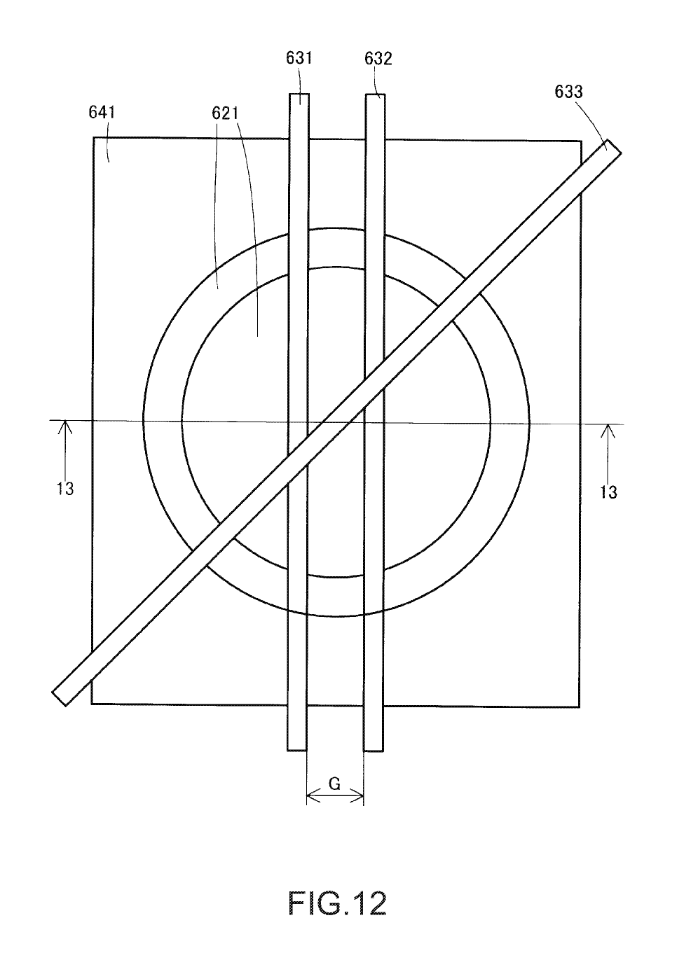

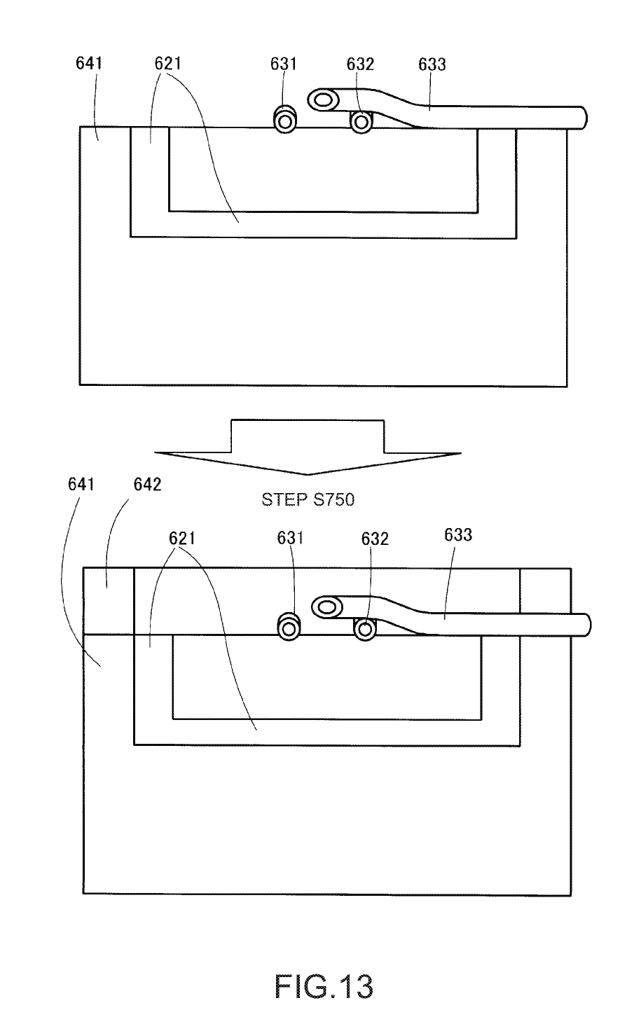

Next, the simulated blood vessel 630 is arranged (Step S740). FIG. 12 is a top view for describing a state where the first simulated blood vessel 631, the second simulated blood vessel 632, and the third simulated blood vessel 633 have been arranged. FIG. 13 is a view for describing a sectional view taken along line 13-13 in FIG. 12 together with an assembly state of the second case member 642. As illustrated in FIGS. 12 and 13, when the blood vessels are arranged in Step S740, the first simulated blood vessel 631 and the second simulated blood vessel 632 are arranged at first predetermined positions, and thereafter, the third simulated blood vessel 633 is arranged at a second predetermined position.

A gap G, i.e. separation, between the first simulated blood vessel 631 and the second simulated blood vessel 632 is preferably set to a distance a little larger than the diameter of the suction pipe 400 (for example 1.25 to 2.5 times larger) (refer to FIG. 1). This enables the suction pipe 400 to be inserted between the first simulated blood vessel 631 and the second simulated blood vessel 632 when incision and excision are performed on the simulated parenchyma 610. However, if the gap G is much wider than the diameter of the suction pipe 400 (for example, greater than 10 times larger), then the presence of one of the first and second simulated blood vessels 631 and 632 in the vicinity of an excision target means that the other of the first and second simulated blood vessels 631 and 632 is less affected by a procedure directed at the excision target. Accordingly, the gap G may be set to approximately several times the diameter of the suction pipe 400 in accordance with the type of tissue being modeled.

Next, the second case member 642 is fixed to the first case member 641 (Step S750). Specifically, as illustrated in a lower section in FIG. 13, the second case member 642 having a rectangular frame shape is placed on the first case member 641. At least the outer, extreme ends of simulated blood vessel 630 at the perimeter of the rectangular frame are pinched by the first case member 641 and the second case member 642, as illustrated in FIG. 3, which shows an outer end of simulated blood vessel 633 pinched between first case member 641 and second case member 642. In this state, the second case member 642 is fixed to the first case member 641 by using a screw (not illustrated). At this point, the case 640 is completed, and an upper region of the first flexible sub-member 621 is exposed (i.e. not yet covered) and surrounded by the second case member 642.

Next, the second flexible sub-member 622 is manufactured (Step S760). The manufacturing method is the same as the manufacturing method (Step S710) of the first flexible sub-member 621. However, the second flexible sub-member 622 has a shape different from that of the first flexible sub-member 621. It has a ring shape. Accordingly, step S760 uses a die different from that used in Step S710.

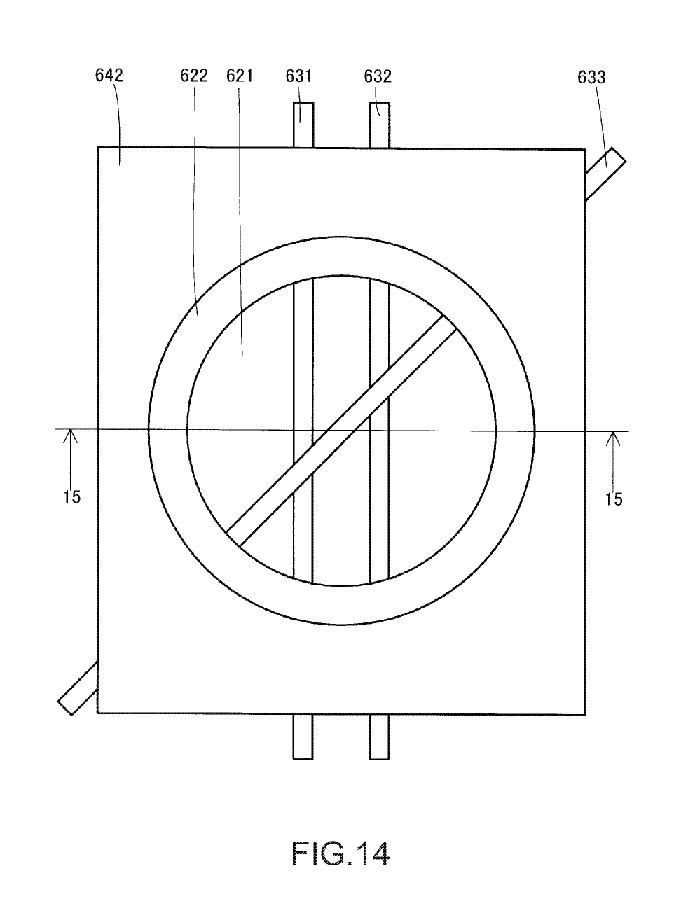

Once constructed, the second flexible sub-member 622 is inserted into a hole (i.e. the opening formed within the perimeter) of the second case member 642 (Step S770). FIG. 14 is a top view showing the second flexible sub-member 622 inserted along the inner perimeter of the rounded (preferably circular) opening of second case member 642.

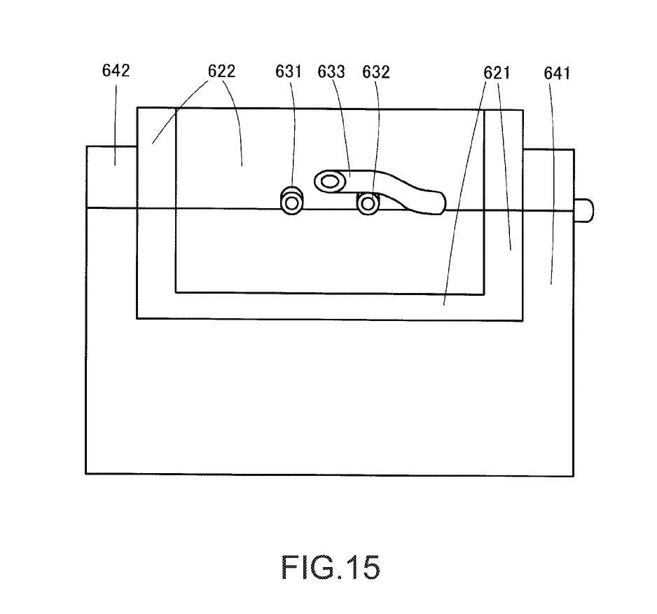

FIG. 15 is a sectional view taken along line 15-15 in FIG. 14. Inserting the second flexible sub-member 622 in Step S770 causes the simulated blood vessel 630 to be pinched between the first flexible sub-member 621 and the second flexible sub-member 622 as illustrated in FIGS. 14 and 15. As illustrated in FIG. 15, the second flexible sub-member 622 may be taller than the second case member 642 and therefore extend upwards above the second case member 642 in Step S770. That is, the second flexible sub-member 622 is manufactured in a ring shape whose thickness (i.e. height) is greater than the height of the second case member 642 constructed in Step S760.

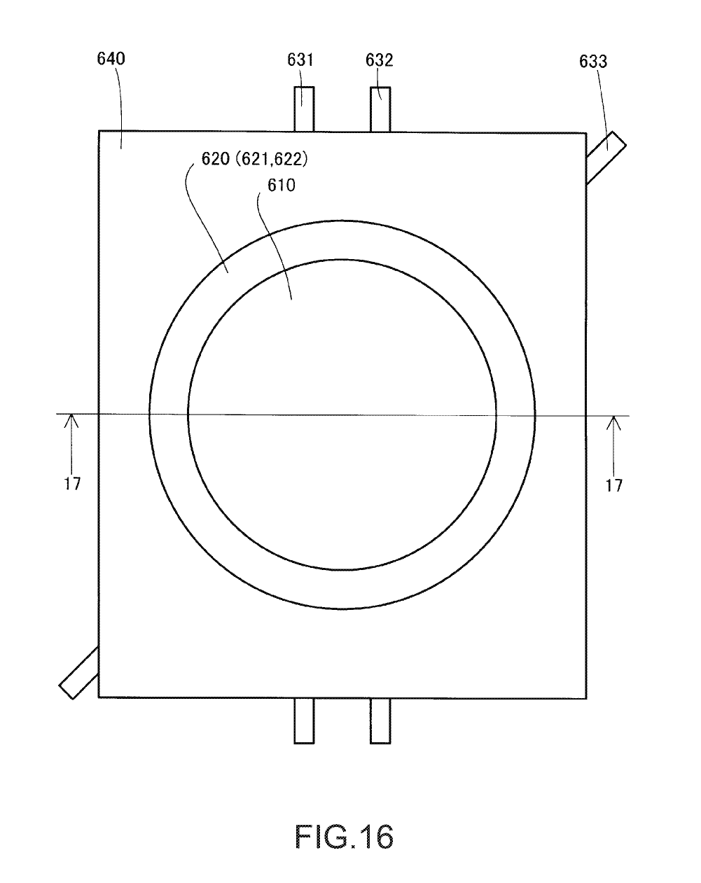

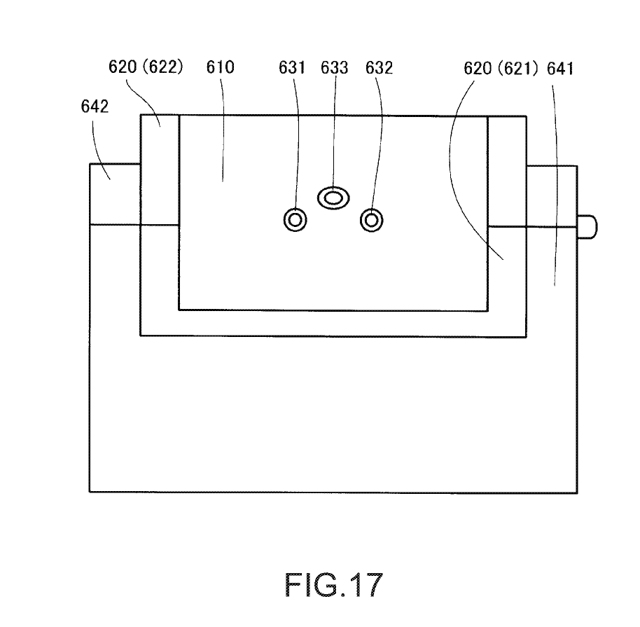

Next, the simulated parenchyma 610 is manufactured and arranged (Step S780) (e.g. poured into the opening defined by the inner perimeter of flexible member 620 so as to engulf the simulated blood vessel 630). FIG. 16 is a top view showing the simulated parenchyma 610 after being arranged. FIG. 17 is a sectional view taken along line 17-17 in FIG. 16. When the simulated parenchyma 610 is manufactured in Step S780, the PVA is used. PVA materials are mixed and cured by freezing. When the simulated parenchyma 610 is arranged, the PVA materials are poured into a recess surrounded by the second flexible sub-member 622. Then, in manufacturing the simulated parenchyma 610, the strength is adjusted by adjusting a mixing ratio of the PVA materials or by changing the manufacturing conditions, so as to obtain the pressing pin breaking strength of 0.01 MPa to 0.07 MPa, the pressing pin elastic modulus of 0.1 kPa to 6 kPa, and the loss elastic modulus of 150 Pa to 800 Pa. As described previously, in manufacturing the simulated parenchyma 610, various adjustments are performed so that the breaking strength and the elastic modulus are one fifth of those of the flexible member 620.

Immediately before the simulated organ 600 is used after Step S780 is completed, the simulated parenchyma 610 and an upper portion of the flexible member 620 are excised, i.e. removed, (Step S790) preferably so as to be substantially flush with the upper surface of case second member 642. In this manner, the simulated organ 600 illustrated in FIGS. 2 and 3 is completely obtained. In the simulated organ 600, the simulated blood vessel 630, whose pressing pin breaking strength is 0.2 MPa, is embedded and included in the simulated parenchyma 610, whose pressing pin breaking strength is 0.01 MPa to 0.07 MPa. The simulated parenchyma 610 and the upper portion of the flexible member 620 correspond to a portion protruding from the upper surface of the case 640.

An excision test of the simulated parenchyma 610 is performed on the obtained simulated organ 600. This excision test may be performed in order to evaluate the performance of the liquid ejecting apparatus 20 illustrated in FIG. 1.

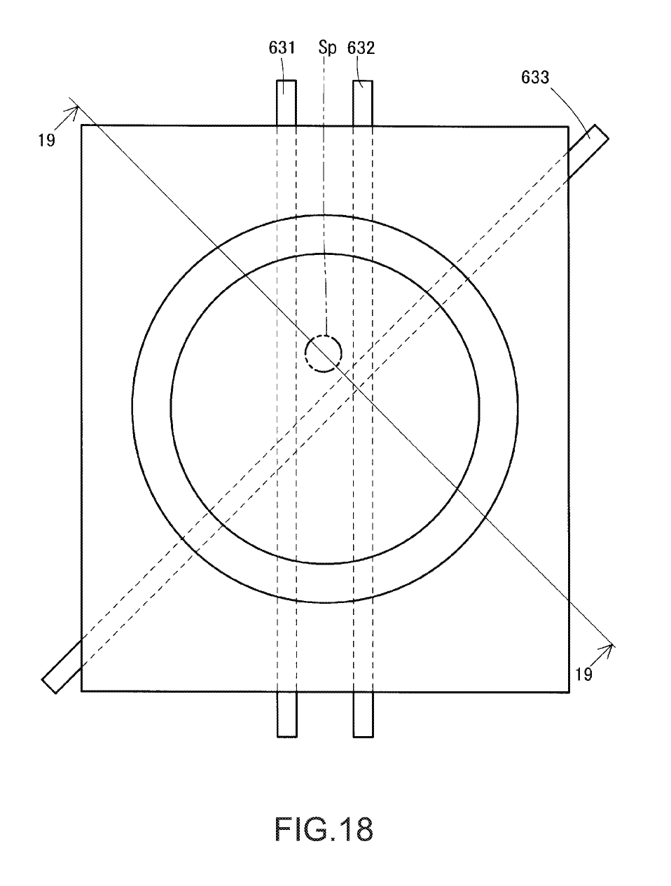

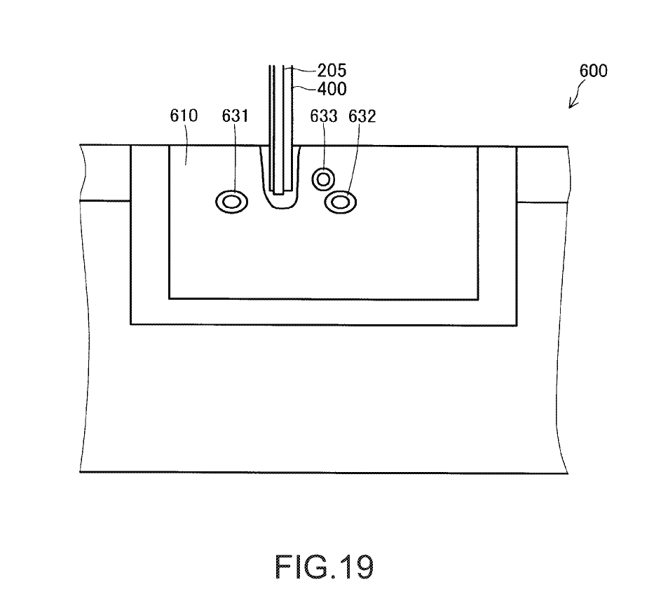

FIG. 18 is a top view for describing an excision portion Sp (i.e. portion or volume that has been excised). FIG. 19 is a sectional view taken along line 19-19 in FIG. 18. The excision portion Sp is selected as a portion located in the vicinity of the intersection (overlap) point between the first simulated blood vessel 631 and the third simulated blood vessel 633, and in the vicinity of the intersection (overlap) point between the second simulated blood vessel 632 and the third simulated blood vessel 633. According to the liquid ejecting apparatus 20, a pulse jet of the liquid ejected from the ejecting tube 205 is adjusted so as to be suitable for incision and excision of the simulated parenchyma 610. It has been confirmed that a pulse jet of liquid intermittently ejected from the ejecting tube 205 after the pulse jet is adjusted enables an operator to perform incision and excision on the simulated parenchyma 610 in the illustrated excision portion Sp without any particular trouble.

In the simulated organ 600 according to the above-described embodiment, the pressing pin breaking strength of the simulated parenchyma 610 is set to 0.01 MPa to 0.07 MPa, and the tensile breaking strength of the simulated blood vessel 630 is set to 0.3 MPa to 1.5 MPa. Accordingly, when practicing incision and excision skills on the simulated parenchyma 610 illustrated in FIG. 19, even if a force to extend (stretch) the simulated blood vessel 630 is applied during an incision and/or excision on the simulated blood vessel 630 due to the pulse jet of the liquid intermittently ejected from the ejecting tube 205, the simulated blood vessel 630 is not damaged. In addition, the pressing pin breaking strength of the above-described simulated parenchyma 610 is substantially the same as that of the cerebral parenchyma cell of the human body, and the tensile breaking strength of the simulated blood vessel 630 is also substantially the same degree as that of the cerebral blood vessel of the human body. As a result, valid operation results can be achieved when an incision or excision is performed on the simulated parenchyma 610 around (i.e. proximate to) the simulated blood vessel 630 of the present invention, with the understanding that the pressing pin breaking strength of the simulated parenchyma 610 reflects that of human cerebral parenchyma cell (s) and that the tensile breaking strength of the simulated blood vessel 630 reflects that of a human cerebral blood vessel.

Additionally in the simulated organ 600 of the above-described embodiment, the pressing pin elastic modulus of the simulated parenchyma 610 is set to 0.1 kPa to 6 kPa, and the tensile elastic modulus of the simulated blood vessel 630 is set to 0.5 MPa to 1.5 MPa. Therefore, valid operation results can be achieved when an incision or excision is performed on the simulated parenchyma 610 around the vicinity of (i.e. proximate to) the simulated blood vessel 630 of the present invention, with the understanding that the pressing pin elastic modulus of the simulated parenchyma 610 reflects that of human cerebral parenchyma cell(s) and that the tensile elastic modulus of the simulated blood vessel 630 reflects that a human cerebral blood vessel.

Additionally in the simulated organ 600 of the above-described embodiment, the loss elastic modulus of the simulated parenchyma 610 is set to 150 Pa to 800 Pa, and the tensile breaking distortion rate of the simulated blood vessel 630 is set to 1.0 to 3.0. Therefore, valid operation results can be achieved when an incision or excision is performed on the simulated parenchyma 610 around (i.e. proximate to) the simulated blood vessel 630 of the present invention, with the understanding that the loss elastic modulus of the simulated parenchyma 610 reflects that of a human cerebral parenchyma (cell) and the tensile breaking distortion rate of the simulated blood vessel 630 reflects that of a human cerebral blood vessel.

In accordance with the presentation invention, an urethane gelling status of urethane is adjusted when the simulated parenchyma 610 is manufactured. In this manner, the pressing pin breaking strength of the simulated parenchyma 610 can be set to a range of 0.015 MPa to 0.03 MPa, the pressing pin elastic modulus can be set to 0.6 kPa to 5 kPa, and the loss elastic modulus can be set to 250 Pa to 400 Pa. Therefore, according to the simulated organ 600 in the embodiment in which the physical property values are adjusted in this manner, the simulated parenchyma 610 can provide operation conditions (e.g. feel and results) similar to those of human cerebral parenchyma due to the pressing pin breaking strength, pressing pin elastic modulus, and loss elastic modulus of the simulated parenchyma 610 closely reflecting those of a cerebral parenchyma (cell) of the human body. As a result, an operator can have an improved sense of realism when performing a simulated operation.

Without being limited to the embodiment, the example, and the modification example which are described herein, the invention can be implemented according to various configurations within the scope of the invention without departing from the present invention. For example, technical features (details) in the embodiment (s) and modification example (s) that correspond to technical features according to aspects of the invention can be appropriately replaced or combined with each other in order to partially or entirely solve the previously described problem or in order to partially or entirely achieve the previously described advantageous effects. If any one of the technical features is not described herein as essential, it may be possible for the technical feature to be omitted. For example, the following configurations can be adopted as an alternative.

In the above described simulated organ 600, the simulated blood vessel 630 is embedded in a simulated parenchyma 610 that together simulate human brain tissue (i.e. a human cerebral parenchyma and a human cerebral blood vessel). However, an organ other than brain tissue can also be simulated. In this case, the pressing pin breaking strength with regard to the simulated parenchyma 610 and the tensile breaking strength with regard to the simulated blood vessel 630 may be adjusted to reflect those of the other tissue (parenchyma cell and the blood vessel) being simulated. This adjusting of parameters can be similarly applied to the above-described physical property values other than the pressing pin breaking strength with regard to the simulated parenchyma 610 and the above-described physical property values other than the tensile breaking strength with regard to the simulated blood vessel 630.

An excise procedure may be applied to the simulated organ 600 using a surgical tool other than the intermittently ejected liquid. For example, the simulated organ 600 may be excised by using a continuously ejected liquid, or may be excised by using a liquid provided with excision capability using an ultrasound. Alternatively, the simulated organ 600 may be excised by using a metal scalpel.

The number of simulated blood vessels 630 may be one, two, four, or more. A configuration may be adopted in which at least one simulated blood vessel 630 is embedded in the simulated parenchyma 610.

In addition, in the above-described embodiments, the simulated blood vessel 630 is hollow, but the simulated blood vessel may alternatively be made solid.

The construction material(s) of the simulated blood vessel 630 is not limited to that in the above-described example. For example, a synthetic resin other than PVA (for example, urethane) may also be used, or a natural resin may also be used.

The material of the simulated parenchyma 610 is not limited to that in the above-described example. For example, a synthetic resin other than PVA (for example, urethane or a rubber-based material) may also be used.

The simulated blood vessel 630 may be manufactured by using injection deposition (3D printing using an ink jet method).

The simulated parenchyma 610 may be manufactured by using 3D printing.

The simulated blood vessel 630 and the simulated parenchyma 610 may be collectively manufactured by using 3D printing. When the 3D printing is performed in this way, an ink may be adjusted in advance so that the above-described strength relationships between the simulated parenchyma 610 and the simulated blood vessel 630 is realized after the ink is dried.

The preferred embodiment adopts a configuration in which a piezoelectric element is used as an actuator. However, the embodiment may adopt a configuration in which liquid is ejected by using an optical maser, a configuration in which the liquid is ejected by a heater generating air bubbles in a liquid, and/or a configuration in which liquid is ejected by a pump pressurizing liquid. According to the configuration in which the liquid is ejected by using the optical maser, the optical maser emits radiation at the liquid so as to generate the air bubbles in the liquid, and using the resultant increased liquid pressure.

The simulated organ 600 according to the above-described embodiment was manufactured to have the above-described specific value ranges for various physical properties such as the pressing pin breaking strength of the simulated parenchyma 610 and the tensile breaking strength of the simulated blood vessel 630, but the configuration is not limited to the above-provided value ranges. For example, the simulated parenchyma 610 may have a pressing pin breaking strength of 0.01 MPa to 0.07 MPa. In this case, an operation status can also be provided on the assumption that incision or excision is performed on the simulated parenchyma 610 having the simulated blood vessel 630 embedded therein, in a state where the pressing pin breaking strength with regard to the cerebral parenchyma cell of the human body is reflected.

Alternatively, the simulated blood vessel 630 may have a tensile breaking strength of 0.3 MPa to 1.5 MPa. In this case, an operation status can also be provided on the assumption that incision or excision is performed on the simulated parenchyma 610 around the simulated blood vessel 630, in a state where damage to the simulated blood vessel 630 is inhibited even if a force to extend the simulated blood vessel 630 is applied to the simulated blood vessel 630.

According to the embodiment, the second case member 642 is fixed onto the first case member 641, thereby configuring the case 640, but the configuration is not limited thereto. Any configuration that fixes the first case member 641 to the second case member 642 so as to prevent unwanted movement relative to each other may be adopted. Alternatively, a configuration may also be adopted in which two members are connected to each other using friction force generated by the two case members coming into contact with each other, or a configuration may also be adopted in which the two members are attachable to, and detachable from, each other.

The embodiment adopts a configuration in which the simulated blood vessel 630 is embedded in the simulated parenchyma 610 traversing the simulated parenchyma 610, the flexible member 620, and the case 640, but the configuration is not limited thereto. A configuration may also be adopted in which the simulated blood vessel 630 traverses at least one of the simulated parenchyma 610, the flexible member 620, and the case 640, or a configuration may also be adopted in which none of the members are traversed. Any configuration may be adopted in which at least a portion of the simulated blood vessel 630 is embedded in the simulated parenchyma. In addition, the embodiment adopts a configuration in which the simulated blood vessel is fixed to the case 640, but the configuration is not limited thereto. A configuration may also be adopted in which the simulated blood vessel is less likely to move by coming into close contact with the simulated parenchyma without being fixed to the case 640.

What is claimed is:

1. A simulated organ comprising:
a simulated blood vessel that simulates a human blood vessel; and
a simulated parenchyma that simulates a human parenchyma cell;
wherein the simulated blood vessel is embedded in the simulated parenchyma;
wherein the simulated parenchyma has pressing pin breaking strength per unit area of 0.01 MPa to 0.07 MPa; and
wherein the simulated blood vessel has tensile breaking strength per unit area of 0.3 MPa to 1.5 MPa.

2. The simulated organ according to claim 1, wherein:
the simulated parenchyma further has a pressing pin elastic modulus per unit area of 0.1 kPa to 6 kPa; and
the simulated blood vessel further has a tensile elastic modulus per unit area of 0.5 MPa to 1.5 MPa.

3. The simulated organ according to claim 1, wherein:
the simulated parenchyma further has a loss elastic modulus of 150 Pa to 800 Pa; and
the simulated blood vessel further has a tensile breaking distortion rate of 1.0 to 3.0.

4. The simulated organ according to claim 3, wherein:
the pressing pin breaking strength per unit area of the simulated parenchyma is further limited to a range of 0.015 MPa to 0.03 MPa;
the pressing pin elastic modulus per unit area of the simulated parenchyma is further limited to a range of 0.6 kPa to 5 kPa; and
the loss elastic modulus of the simulated parenchyma is further limited to a range of 250 Pa to 400 Pa.

5. A simulated organ comprising:
a simulated blood vessel that simulates a human blood vessel; and
a simulated parenchyma that simulates a human parenchyma cell;
wherein the simulated blood vessel is embedded in the simulated parenchyma; and
wherein the simulated parenchyma has pressing pin breaking strength per unit area of 0.01 MPa to 0.07 MPa.

6. A simulated organ comprising:
a simulated blood vessel that simulates a human blood vessel; and
a simulated parenchyma that simulates a human parenchyma cell;
wherein the simulated blood vessel is embedded in the simulated parenchyma; and
wherein the simulated blood vessel has tensile breaking strength per unit area of 0.3 MPa to 1.5 MPa.
